(19) United States
(12) Patent Application Publication
(10) Pub. No.: US 2011/0038685 A1
(43) Pub. Date: Feb. 17, 2011

(54) FEMALE PART FOR A FASTENER, THE FEMALE PART ALIGNING WITH A HOLE IN A PANEL

(76) Inventors: Eberhardt CHRIST, Tambach-Dietharz (DE); Marko GÖRING, Gotha (DE)

Correspondence Address: BIRCH STEWART KOLASCH & BIRCH, PO BOX 747, FALLS CHURCH, VA, 22040-0747, US

(21) Appl. No.: 12/912,247

(22) Filed: Oct. 26, 2010

Related U.S. Application Data
(62) Division of application No. 11/504,018, filed on Aug. 15, 2006.

(30) Foreign Application Priority Data
Aug. 31, 2005 (DE) 10 2005 041 350.1

(51) Int. Cl. F16B 37/00

(52) U.S. Cl. 411/82; 411/103

(57) ABSTRACT

A female part for an insertable fastener, more especially a screw. The female part is be aligned with a hole in a panel, with a radial extension adapted to contact the panel. The female part is provided with a drive receiving means and the extension is provided, on its carrying surface facing the panel, with a ring, surrounding the female part, of a hot-melt adhesive. The hot-melt adhesive is adapted to be melted on through rotational friction.

### CROSS-REFERENCE TO RELATED APPLICATION

The present application is a Divisional Application of U.S. patent application Ser. No. 11/504,018 filed on Aug. 15, 2006, and claims priority under 35 U.S.C. §119 to German Patent Application No. 10 2005 041 350.1, filed Aug. 31, 2005, the entire contents of which are hereby incorporated by reference.

### BACKGROUND OF THE INVENTION

1. Field of the Invention

The invention relates to a female part for a therein insertable fastener, more especially a screw, said female part aligning with a hole in a panel, with a radial extension adapted to contact the panel.

2. Description of Background Art

Such a female part is disclosed in EP 0 358 896 B1. The known female part consists of a sleeve, open at both ends, with a female thread into which a screw, serving as the fastener, can be screwed in order to secure some component. The female part is provided with a flange, one side of which faces a panel into which the female part is inserted. Sandwiched between the respective side of the flange and the respective surface of the female part is an annular adhesive film which is softened through externally applied heating and thus adhesively affixes the flange to the panel. The heating is produced by a heated annular tool which is applied to the panel, the execution of the heating operation presenting difficulties because, for this purpose, the tool must be securely held especially in contact with the panel. Namely, the tool surrounds the head of a bolt which has been screwed into the female part, without the tool being securely held by said bolt. The flow of heat goes from the outer edge of the tool into the panel and from there, as it were, backwards into the adhesive film, it then being necessary to wait until the adhesive film has been heated and cooled down again, so that the female part, together with the bolt, is unable to drop out of the panel.

A similar design of a female part attachable to a panel is described in U.S. Pat. No. 5,636,953. According to this patent specification, an annular disk of a meltable plastic is inserted between a flange of a female part, said female part being inserted into the hole in a panel, and the panel. In an oven, the plastic is then melted on, thereby penetrating openings in the flange, this resulting in a sealing connection between panel and female part. Also in this case, therefore, the heating of the plastic is accomplished through external application.

Finally, reference is additionally to be made to EP 0 140 568 B1, in which a bell-shaped female part is placed onto an unholed panel and is glued to a flange on the panel. The therein used adhesive extends all over the side of the female part facing the panel, thus completely covering the axial opening thereof. The hot-melt adhesive is melted on by rotating the female part and through the thereby produced frictional heat. Said known female part is unsuitable for the attachment of components by means of long bolts, because it provides no opening firstly in the region with the hot-melt adhesive or secondly in the panel carrying the female part, with the consequence that said female part cannot be used as a female part which is insertable into a hole in a panel.

### SUMMARY AND OBJECTS OF THE INVENTION

The object of the invention is to design the initially described female part such that, firstly, it can, in connection with its attachment to a panel, be quickly attached to the panel without complex measures and such that, secondly, it is ensured that, despite the existence of the hole, the panel provides a secure seal through the female part with the therein inserted fastener. The object of the invention is achieved in that the female part is provided with a drive receiving means and the extension is provided, on its carrying surface facing the panel, with a ring, surrounding the female part, of a hot-melt adhesive, said hot-melt adhesive being adapted to be melted on through rotational friction.

Owing to this design, the female part according to the invention can, upon being introduced into the hole in a panel, be quickly and easily connected thereto, this being achievable using an insertion tool which at the same time ensures the necessary rotation of the female part in order to produce the rotational friction. This can be accomplished in one integrated operation, wherein the arrangement of a drive receiving means for an internal drive on the female part provides the assurance that the respective drive is able to act directly on the female part, this allowing an especially energy-saving method of attachment. Instead of an internal drive on the female part, the drive receiving means thereof may alternatively be provided with an external drive.

The extension is advantageously in the form of a radial flange. It is, however, also possible to provide the extension with the shape of a cone which is then inserted into a corresponding hole in the female part. The application of the hot-melt adhesive is not necessarily restricted to the extension or the flange. Rather, it is also possible for the adhesive layer to be extended to the female part, this correspondingly extending the region of the connection between panel and female part.

In order to allow the melted hot-melt adhesive to flow not only radially outwards along the extension, the flange is advantageously provided with openings for the passage of melted hot-melt adhesive, which, upon melting, is thus able to pass directly through the flange, this preventing any smearing in the region radially next to the flange.

In order to lend a certain flexibility to the connection between flange and panel, the flange may advantageously be of such design that the thickness of the flange decreases radially outwards. This results in a certain flexibility of the female part in relation to the panel, because the flange, by reason of its radially outwards decreasing cross-section, adheres to the panel with a certain elasticity. In order to ensure that the hot-melt adhesive has a good hold on the carrying surface of the extension, the carrying surface is advantageously provided with at least one continuous groove.

The female part is advantageously provided with snap-fit hooks, said snap-fit hooks snapping into a panel from behind when the female part is inserted. The snap-fit hooks allow a female part to be quickly and easily premounted on a panel.

The female part may be attached to a panel in opposite directions. For this purpose, the carrying surface for the hot-melt adhesive may be on the side of the flange situated to either the front or the rear in the insertion direction of the fastener.

In order to provide the female part with a good sealing effect, the female part may be closed off by a base.

The position of the female part in relation to the panel may advantageously be locked also in that, for this purpose, the female part is given a special form, namely in that the extension transitions in a thin-walled neck portion into a screw boss, said screw boss receiving the fastener, wherein the neck portion is compressible to form a radial fold when the fastener is tightened, such that the radial fold engages behind the panel to act as a locking means in the manner of a snap-fit hook. When, after insertion of the female part into the panel, for example a screw is screwed into the female part and the screw boss is tightened, then there is formed the outwardly directed radial fold, said radial fold engaging behind the panel and thus securing the female part against being pulled away from the panel.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view of the female part;

FIG. 2 shows the same female part in section along line II-II from FIG. 1;

FIG. 3a shows the female part in a top plan view with its round flange and the hexagonal internal drive receiving means;

FIG. 3b presents a variation in relation to FIG. 3a in which the flange 2 is in the form of a hexagon, this resulting in an external drive receiving means

FIG. 4 shows a female part in section with conical flange;

FIG. 5 shows a female part in section with adhesive layer extended to the female part;

FIG. 6 shows a female part in section with radially outwards decreasing thickness of the flange;

FIG. 7 shows a female part in section with snap-fit hook;

FIG. 8 shows a female part with a flange disposed in the region of the base, said base closing off the female part;

FIG. 9 shows a female part of a flange provided with openings, attached to a panel;

FIG. 10 shows the female part from FIG. 9, attached to a panel;

FIG. 11 shows the female part in section with a carrying surface for the hot-melt adhesive on the rear side of the flange;

FIG. 12 shows the female part from FIG. 11 attached to a panel; and

FIGS. 13 and 14 show the special connection between extension and female part by means of a thin-walled neck portion, said neck portion forming a radial fold to act as a locking means.

### DETAILED DESCRIPTION OF THE PREFERRED EMBODIMENTS

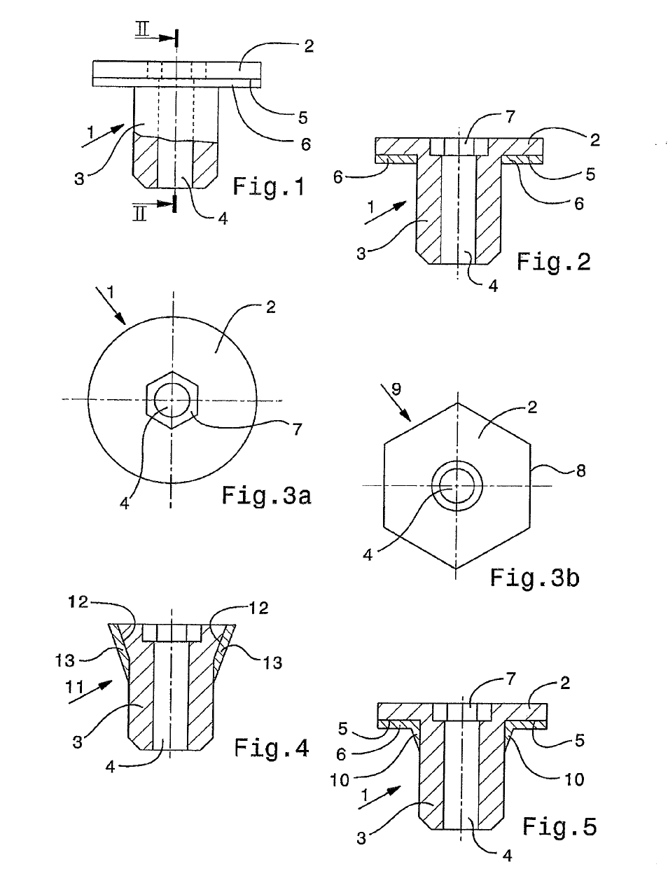

FIG. 1 presents the female part 1 with the extension, said extension being in the form of the flange 2. The female part 1 comprises the screw boss 3, which adjoins the flange 2 and which, together with the flange 2, is penetrated by the bore 4. The bore 4 serves to receive a fastener (not shown in FIG. 1), more especially a screw. On the side of the flange 2 facing the screw boss 3, the flange 2 forms the carrying surface 5 for a hot-melt adhesive 6, said hot-melt adhesive 6 being applied in the form of a ring and being adapted to be melted on through rotational friction.

FIG. 2 presents the female part 1 from FIG. 1 in section along line II-II from FIG. 1. It can be seen from FIG. 2 that the bore 4 widens in the region of the flange 2 to form a hexagon socket serving here as an internal drive receiving means 7 for rotating the female part 1 when the female part 1 is being attached to a panel.

FIG. 3a shows the female part 1 in a top plan view with its round flange 2 and the hexagonal internal drive receiving means 7.

FIG. 3b presents a variation in relation to FIG. 3a in which the flange 2 is in the form of a hexagon, this resulting in an external drive receiving means 8 for the attachment of the respective female part 9.

FIG. 4 presents a female part 11 in which the extension is in the form of a cone 12. Accordingly, the coating 13 with the hot-melt adhesive is also correspondingly conical in form. Otherwise, the female part 11 is completely identical to that presented in FIGS. 1 and 2.

FIG. 5 presents a female part 1 which, with regard to its internal design, is completely identical to the female part presented in FIG. 1, albeit with a slightly different coating of the flange 2. In this case, the flange 2 is coated with the hot-melt adhesive 6 not only on its carrying surface 5, but also the outer circumference of the female part 1 in the region of the screw boss 3 thereof (coating 10), this resulting in a correspondingly extended coating of the female part 1 and therefore in an improved possibility of attachment thereof.

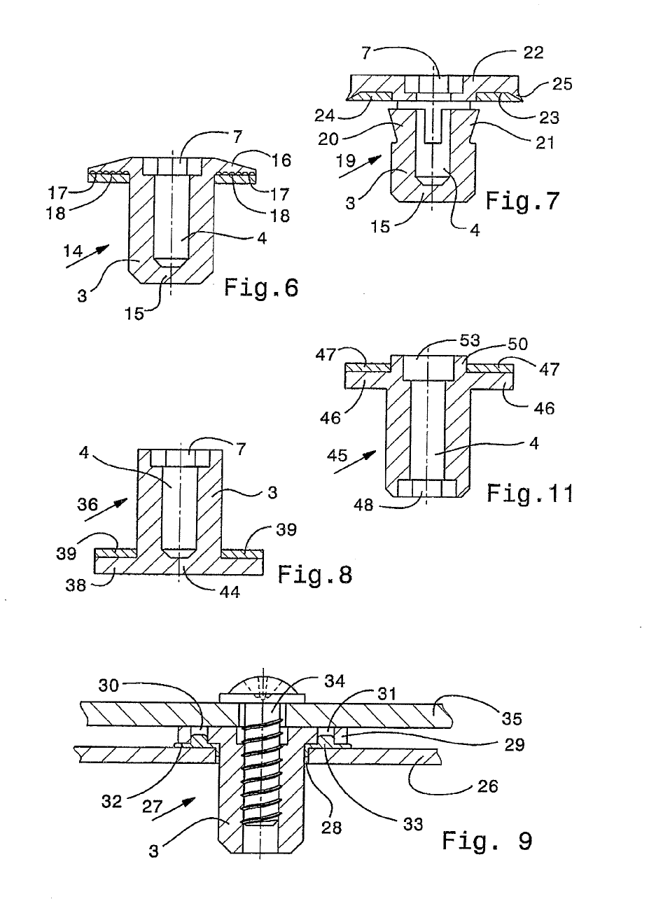

FIG. 6 presents the female part 14, which, in contrast to the female parts presented in the above-discussed Figures, is a female part which is closed off by a base 15 and which, consequently, is able to exert a corresponding sealing effect. In addition, the female part 14 has the peculiarity of a flange 16 which decreases radially outwards in the thickness thereof. Furthermore, the carrying surface 17 is provided with a plurality of annularly extending grooves 18, the purpose of which is to ensure an effective connection between an applied hot-melt adhesive and the carrying surface 17 of the flange 16.

FIG. 7 presents a female part 19 which is additionally provided with the two snap-fit hooks 20 and 21, which snap-fit hooks 20 and 21 are, when the female part 19 is inserted into the hole in a panel, pressed back by the inside edge of the hole and, when the female part 19 has been fully inserted into the hole in the panel, snap back out, thereby locking the female part 19 in position on a panel. Like the female parts presented in FIGS. 1 and 2, the female part 19 is provided with the flange 22, to the carrying surface 23 of which is applied the hot-melt adhesive layer 24. At its outside edge, the carrying surface 23 transitions into the projecting sealing lip 25, which annularly surrounds the hot-melt adhesive layer 24 and ensures that the hot-melt adhesive, upon melting, escapes laterally only to a minor extent from the region of the flange 22.

Otherwise, reference is made to the explanatory remarks in relation to the above Figures.

FIG. 8 presents a variant of a female part, which, in this case, is the part 36, which is provided in the region of its base 44 with the flange 38. Applied to the flange 38 is the layer of hot-melt adhesive 39 with which the female part 36, while being rotated, can be pressed against a panel in order to be joined thereto through heat-bonding.

FIG. 9 presents a female part 27 attached to the panel 26, said female part 27 penetrating, with its screw boss 3, the hole 28 in the panel 26. The female part 27 is provided with the flange 29, said flange 29 comprising the openings 30 and 31. Applied to the carrying surface 32 of the flange 29 is the hot-melt adhesive 33, which, upon being heated through rotation of the female part 27, is able to flow away into the openings 30 and 31 and which, therefore, does not emerge at the sides to cause any problems. The rise of hot-melt adhesive in the openings 30 and 31 indicates that the bonding operation is completed. In this case, the purpose of the female part 27 is to be secured to the panel 26 by means of the screw 34, for which purpose the screw 34 is screwed into the screw boss 3 and, with its head 36, presses the component 35 against the flange 29 and therefore also against the panel 26.

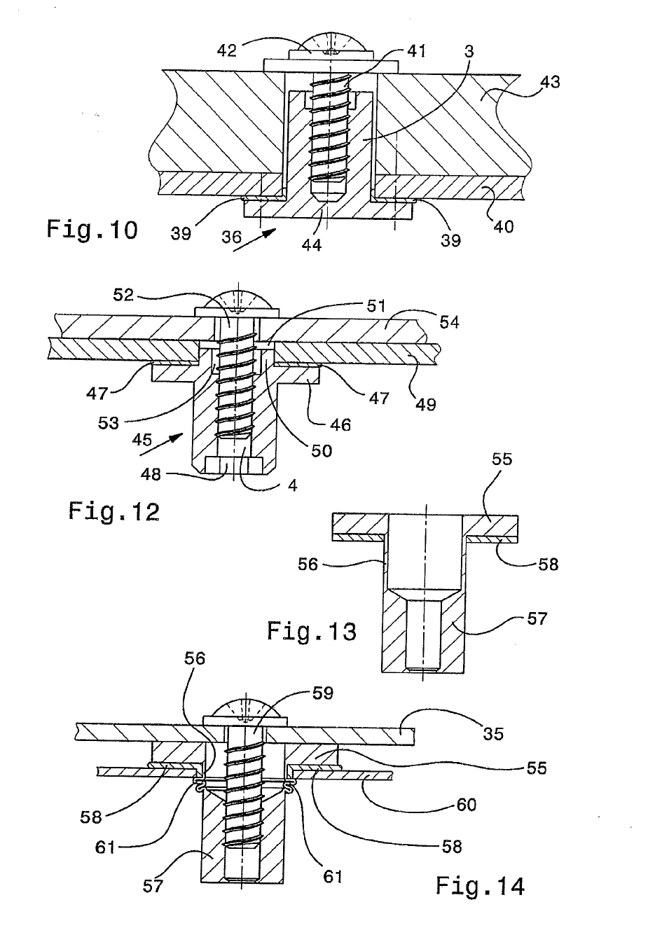

FIG. 10 presents such a connection. Here, it is shown how the female part 36, while being rotated, is pressed, with its layer of hot-melt adhesive 39, against the surface of the panel 40 and is joined thereto, with the result that the open female part 36 is available for the attachment of the screw 40. Upon being screwed in, the screw 40 pulls the component 42 up against the panel 40 with the washer 41, which washer 41 is supported by the screw 40. Since the female part 36 is provided with the base 44, there is thus formed a leak-tight connection, this to a large extent preventing the passage of liquid from the one side of the component 43 to the respective other side of the panel 40.

FIGS. 11 and 12 present a further variation, in which the female part 45 is provided with the hot-melt adhesive 47 on an opposite side of the flange 46 in comparison with the carrying surface for the hot-melt adhesive in the above-presented Figures. The female part 45 is provided with the internal drive receiving means 48, the purpose of which, as similarly described above, is to set the female part 45 in rotation, thereby melting the hot-melt adhesive 47, this then resulting in the secure connection to the panel 49.

The female part 45 is provided on the side of the flange 46 with the collar 50, said collar 50 fitting into the hole 51 in the panel 49 and thereby forming a guide for the insertion of the female part 45 into the hole 51. The bore 4 in the female part 45, said bore 4 receiving the screw 52, widens out on the side of the flange 46 to form the relief bore 53, the purpose of which is to facilitate the introduction of the screw 52 into the female part 45. The purpose of the screw 52 is to secure the component 54 to the panel 49.

A variation on the locking in position of the completely inserted female part 19 by means of the two snap-fit hooks 20 and 21, as presented in FIG. 7, is presented in FIGS. 13 and 14, FIG. 13 showing the female part alone without a panel and FIG. 14 showing the female part having been inserted into a panel with a tightened screw as the fastener insertable into the female part.

In FIG. 13, the extension 55 transitions via the thin-walled neck portion 56 into the screw boss 57, which screw boss 57 is provided in the region adjoining the neck portion 56 in order to receive a fastener, more especially a screw (see FIG. 14). The extension 55 is further provided with the hot-melt adhesive layer 58, the purpose of which is to bond the female part to a panel through hot-bonding.

This connection is presented in FIG. 14, in which a screwed-in screw 59 serves as the fastener. The screw 59, screwed into the screw boss 57, pulls the screw boss 57 up against the panel 60, the thin-walled neck portion 56 being deformed to form the radial fold 61. Said fold projects radially outwards from the screw boss 57, thereby forming a contact with one side of the panel 60, this resulting in the locking in position of the female part, similarly to the effect of the snap-fit hooks 20 and 21 presented in FIG. 7. The hot-melt adhesive layer 58 is squeezed together and is pressed into the annular gap between the neck portion 56 and the opening in the panel 60, this resulting in an additional region of the bond between female part and panel.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. Female part into which a screw fastener is insertable, said female part being adapted to align with a hole in a panel, the female part comprising:
a radial extension adapted to contact the panel; and
a ring of hot-melt adhesive provided on a carrying surface of the radial extension facing the panel and surrounding the female part,
wherein said ring of hot-melt adhesive is adapted to be melted on the panel through rotational friction,
wherein said ring of hot-melt adhesive provided on the carrying surface of the radial extension surrounds the female part at a position in an axial direction that is inward from and away from each end of the female part,
wherein the extension transitions in a thin-walled neck portion into a screw boss, said screw boss receiving the screw fastener, wherein the neck portion is compressible to form a radial fold when the screw fastener is tightened, such that the radial fold engages behind the panel to act as a locking means in the manner of a snap-fit hook.
